(19) United States
(12) Patent Application Publication
(10) Pub. No.: US 2005/0271240 A1
(43) Pub. Date: Dec. 8, 2005

(54) Speaker device and method of manufacturing the speaker device

(75) Inventors: Seiya Sato, Yamagata-ken (JP); Hiroyuki Tomiyama, Yamagata-ken (JP)

Correspondence Address: ARENT FOX PLLC, 1050 CONNECTICUT AVENUE, N.W., SUITE 400, WASHINGTON, DC, 20036, US

(73) Assignees: Pioneer Corporation; Tohoku Pioneer Corporation

(21) Appl. No.: 11/137,555

(22) Filed: May 26, 2005

(30) Foreign Application Priority Data
May 27, 2004 (JP) JP 2004-158063

(51) Int. Cl. H04R 25/00

(52) U.S. Cl. 381/404

(57) ABSTRACT

It is an object of the present invention to provide a speaker device equipped with a damper having an improved durability. Namely, the speaker device is equipped with a damper containing aramid fiber. An adhesive material is interposed between the damper and a frame. A perimeter edge portion of the damper is clamped between the frame and a ring-shaped member arranged along the perimeter edge portion, with screws driven down trough related material layers, thereby fixing the damper on the frame.

### BACKGROUND OF THE INVENTION

The present invention relates to a speaker device and a method of manufacturing the speaker device.

The present application claims priority from Japanese Application No. 2004-158063, the disclosure of which is incorporated herein by reference.

FIG. 1 is an explanatory view showing a conventional speaker device disclosed in Japanese Unexamined Patent Application Publication No. Hei 06-14383. As shown, the conventional speaker device has a center pole 2 consisting of a magnetic material and located in the center of the speaker device. A yoke 3 including the center pole 2 has an inverted T-shaped cross section involving a number of shoulders. A ring-shaped magnet 4 having a predetermined thickness is disposed along the circumferential edge portion of the yoke 3, with a predetermined annular space formed between the center pole 2 and the ring-shaped magnet 4. Further, a ring-shaped plate 5 is disposed on the upper surface of the magnet 4, thereby forming a magnetic circuit consisting of the yoke 3, the magnet 4, and the ring-shaped plate 5.

A frame 6 consisting of a metal is mounted on the ring-shaped plate 5, forming a funnel-like structure including an annular flat portion 6A to which a perimeter edge portion of a damper D is bonded by virtue of an adhesive material S. Besides, an annular clearance 7 is formed between the center pole 2 and the inner circumferential wall of the plate 5, thus admitting a cylindrical voice coil bobbin 8 surrounding the center pole 2, as well as a voice coil 9 winding around the voice coil bobbin 8. An upper portion of the voice coil 9 winding around the voice coil bobbin 8 is fixed with the damper D, while a further higher portion thereof is fixed with a diaphragm 10, with the other end of the diaphragm 10 connected with the edge of the frame 6. In addition, a terminal 11 is disposed on the outside of the frame 6 and connected via a brocade thread 12 to a lead wire (not shown) extending from the voice coil 9, in a manner such that a sound signal obtained by the terminal 11 can be supplied to the voice coil 9 through the lead wire. Furthermore, a dust proof cap 13 is provided on the top of the voice coil bobbin 8.

However, the speaker device disclosed in Japanese Unexamined Patent Application Publication No. Hei 06-14383 has suffered from a problem that the damper D will be damaged due to an intense vibration or a high input, rendering it impossible to maintain a desired function. On the other hand, although the frame 6 and the damper D have been bonded together by virtue of the adhesive material S interposed therebetween, they would still be separated from each other due to an intense vibration.

Furthermore, with a trend of making a speaker device compact in size and thin in thickness, the small and thin speaker device 1 has been confronted with a problem that the lowest resonance frequency f₀ will generally become relatively high, making it difficult to produce a low volume sound. This is because the speaker device 1, which as a whole has been made light in weight, has reduced an equivalent mass m₀ of the vibration system of the speaker device.

### SUMMARY OF THE INVENTION

The present invention has been accomplished to solve the above-mentioned problem as one of its task and it is an object of the present invention to increase the strength of the damper of a speaker device and to prevent an exfoliating of the damper from the frame.

To achieve the foregoing object, the speaker device of the present invention comprises at least the following features according to the following aspects.

According to one aspect of the present invention, there is provided a speaker device having a damper containing aramid fiber. In particular, a perimeter edge portion of the damper is clamped between a frame and a ring-shaped member arranged along the perimeter edge portion of the damper, thereby fixing the damper on the frame.

According to another aspect of the present invention, there is provided a method of manufacturing a speaker device formed by fixing a damper containing aramid fiber on a frame. In particular, a perimeter edge portion of the damper is clamped between the frame and a ring-shaped member arranged along the perimeter edge portion, thereby allowing the perimeter edge portion of the damper to be fixed on the frame.

### BRIEF DESCRIPTION OF THE DRAWINGS

These and other objects and advantages of the present invention will become clear from the following description with reference to the accompanying drawings, wherein:

FIG. 1 is an explanatory view showing a speaker device according to a prior art;

FIG. 2 is an explanatory view showing a speaker device according to an embodiment of the present invention;

FIG. 3 is an explanatory plan view showing a damper of the speaker device according to the embodiment of the present invention; and

FIG. 4 is an enlarged cross sectional view showing a fixing structure of the speaker device of FIG. 2.

### DETAILED DESCRIPTION OF THE PREFERRED EMBODIMENTS

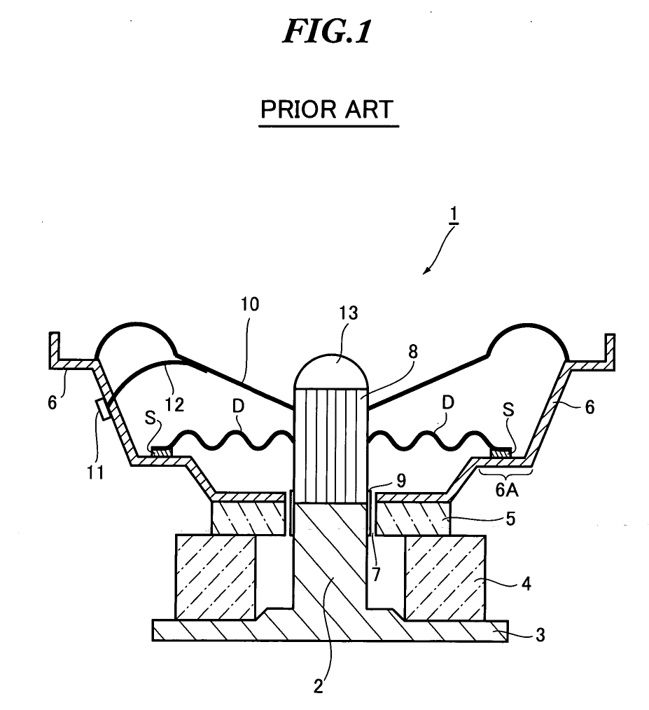

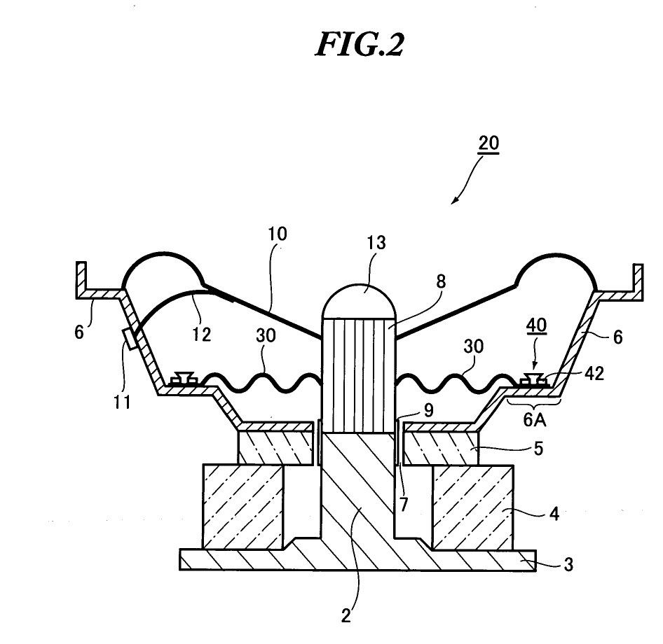

In the following, an embodiment of the present invention will be described with reference to the accompanying drawings. FIG. 2 is a cross sectional view showing a speaker device formed according to the embodiment of the present invention. However, elements which are identical with those forming the conventional speaker device 1 shown in FIG. 1 will be represented by the same reference numerals and the same explanations are omitted.

As shown, the present embodiment of the present invention comprises a damper 30 containing aramid fiber, with the perimeter edge portion thereof fixed on a frame 6 by clamping the same on the frame 6 using a ring-shaped member 42 attached along the perimeter edge portion of the damper 30. Here, the damper 30 and the frame 6 are fixed with each other by virtue of a fixing structure 40 provided on a flat portion 6A of the frame 6. Here, although the present embodiment of the present invention shows the fixation between the damper 30 and the flat portion 6A, the position for fixing the damper on the frame should not be limited to the flat portion.

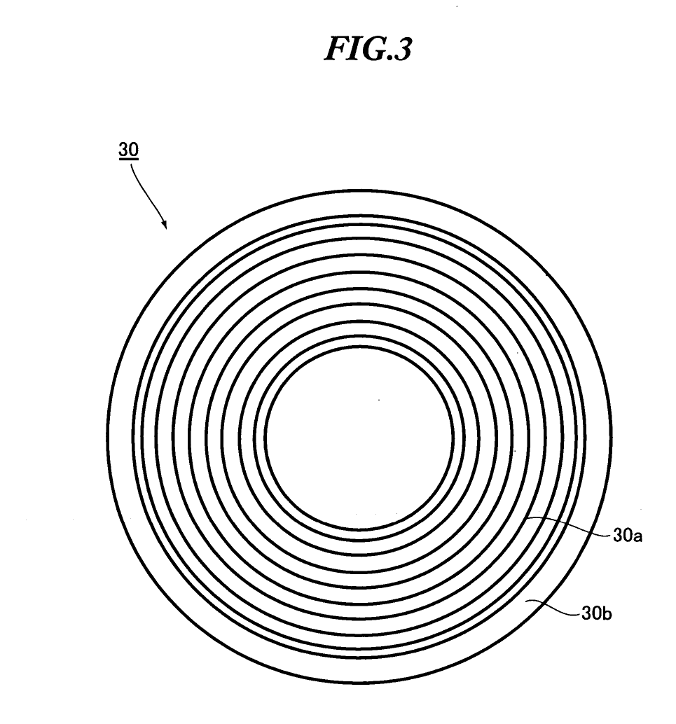

FIG. 3 is a plan view showing the damper 30 formed according to the present embodiment of the present invention. As shown, the damper 30 consists of a concentrically formed wave portion 30a and its perimeter edge portion 30b. The entire or part of the wave portion 30a contains aramid fiber (for example, poly-aramid fiber, or para-aramid fiber). Since the perimeter edge portion 30b forms the outer circumference of the wave portion 30a, and serves as a flat surface continuously and integrally formed with the wave portion 30a, it is formed of the same material as that forming the wave portion 30a containing aramid fiber, with the ring-shaped member 42 (attached along the perimeter edge portion 30b) arranged on the perimeter edge portion 30b.

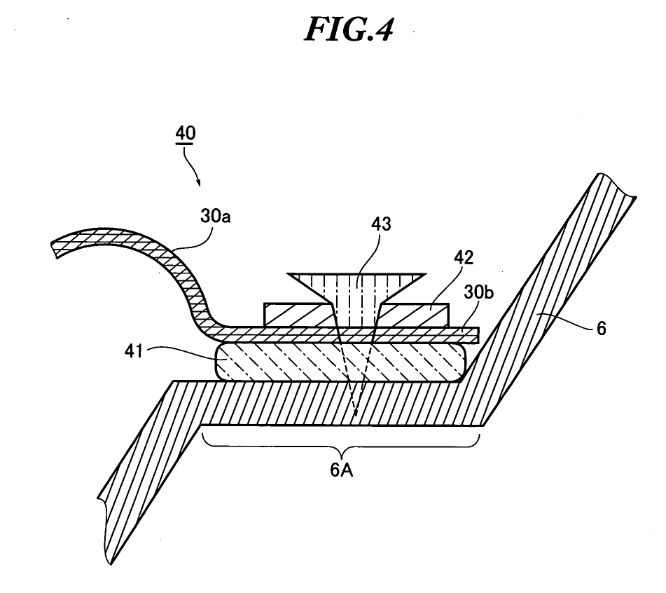

FIG. 4 is an enlarged sectional view showing the fixing structure 40 formed according to the embodiment of the present invention. As shown, the fixing structure 40 comprises an adhesive material 41, the ring-shaped member 42 and screws 43, so that the perimeter edge portion 30b of the damper 30 can be clamped between the flat portion 6A of the frame 6 and the ring-shaped member 42, with the screws 43 driven down through the related material layers so as to effect a screwed fixation.

Next, description will be given to explain a fixing method with reference to FIG. 4. At first, an amount of the adhesive material 41 is applied to the flat portion 6A consisting of part of the frame 6, followed by disposing the perimeter edge portion 30b of the damper 30 (containing aramid fiber) on the adhesive material 41. Here, although the adhesive material 41 should not receive any limitation, it is preferable to employ a material having an acceptable adhesion with aramid fiber, for the simple reason that the damper 30 is formed of a material containing aramid fiber which is used for the purpose of reinforcement. Further, in terms of the thickness of aramid fiber and the weaving density thereof, it is preferable to select an appropriate material for use as the adhesive material 41. For example, it is possible to use an adhesive material mainly containing chloroprene, nitrile rubber and the like, an adhesive material of acrylic resin system, or an adhesive material of silicon system.

Next, the ring-shaped member 42 is placed on the perimeter edge portion 30b of the damper 30 bonded with the adhesive material 41. In fact, the ring-shaped member 42 is in the form of an annular configuration along the perimeter edge portion 30b of the damper 30, and can be made of any desired material without any limitation. Moreover, the ring-shaped member 42 is formed with holes (not shown) in desired positions and the screws 43 are then screwed into these holes, thereby forming a firmly fixed structure between the damper 30 and the frame 6. Here, each screw 43 should be so formed that its sharpened end can pass through the perimeter edge portion 30b of the damper 30 and through the adhesive material 41, so as to reach the flat portion 6A of the frame 6, or even pass through the flat portion 6A.

Therefore, according to the above-described embodiment of the present invention, the adhesive material 41 is at first interposed between the flat portion 6 and the perimeter edge portion 30b of the damper 30. Then, the ring-shaped member 42 is placed on the perimeter edge portion 30b, and the screws 43 are driven down through the related material layers, thereby obtaining a speaker device 20 having a firmly fixed structure between the damper 30 and the frame 6.

As described above, according to the speaker device and the speaker device manufacturing method of the present embodiment of the present invention, using the damper containing aramid fiber makes it possible to increase the strength of the damper. Meanwhile, interposing the adhesive material between the frame and the perimeter edge portion of the damper, clamping the perimeter edge portion of the damper with the ring-shaped member disposed along the perimeter edge portion, and driving the screws through related material layers, together effect an exact and firm fixation between the damper and the frame.

Furthermore, since using the aramid fiber can increase a cutting strength and using the ring-shaped member can ensure a uniform pressing force applied to the perimeter edge portion of the damper, it is possible to avoid a cracking on the perimeter edge portion of the damper even if screws are used in the required fixation.

Furthermore, according to the above-described embodiment of the present invention, since fixing elements such as adhesive material, ring-shaped member and screws or the like are disposed on the flat portion (part) of the frame, an equivalent mass of the vibration system of the speaker device is increased, so that it is possible to inhibit the lowest resonance frequency f₀, thus obtaining a high power speaker device effective for low volume output.

While there has been described what are at present considered to be preferred embodiments of the present invention, it will be understood that various modifications may be made thereto, and it is intended that the appended claims cover all such modifications as fall within the true spirit and scope of the invention.

1. A speaker device comprising:
a damper containing aramid fiber,
wherein a perimeter edge portion of the damper is clamped between a frame and a ring-shaped member arranged along the perimeter edge portion of the damper, thereby fixing the damper on the frame.

2. The speaker device according to claim 1, wherein the perimeter edge portion of the damper is fixed by fixing the ring-shaped member on the frame by virtue of screws.

3. The speaker device according to claim 1 or 2, wherein adhesive material is interposed between the damper and the frame.

4. A method of manufacturing a speaker device formed by fixing a damper containing aramid fiber on a frame, wherein a perimeter edge portion of the damper is clamped between the frame and a ring-shaped member arranged along the perimeter edge portion, thereby allowing the perimeter edge portion of the damper to be fixed on the frame.
